(19) United States
(12) Patent Application Publication
(10) Pub. No.: US 2012/0219035 A1
(43) Pub. Date: Aug. 30, 2012

(54) TEMPERATURE ESTIMATION APPARATUS AND METHOD IN THERMOCOUPLE INPUT MODULE OF PLC

(75) Inventor: JAE IL KWON, Seoul (KR)

(73) Assignee: LSIS CO., LTD., Anyang (KR)

(21) Appl. No.: 13/399,959

(22) Filed: Feb. 17, 2012

(30) Foreign Application Priority Data
Feb. 28, 2011 (KR) 10-2011-0017753

(51) Int. Cl. G01K 7/02

(52) U.S. Cl. 374/170; 374/E07.004

(57) ABSTRACT

Disclosed is a temperature estimation apparatus and a method in thermocoupler input module of PLC, wherein the estimation according to the present invention is performed in such a manner that an analogue signal corresponding to a thermo-electromotive force is converted to a digital data, and the estimation is performed using a predetermined temperature estimation function corresponding to the thermo-electromotive force converted to the digital data.

Pursuant to 35 U.S.C. §119 (a), this application claims the benefit of earlier filing date and right of priority to Korean Patent Application No. 10-2011-0017753, filed on Feb. 28, 2011, the contents of which is hereby incorporated by reference in their entirety.

### FIELD OF THE DISCLOSURE

The teachings in accordance with the exemplary embodiments of this present invention generally relate to a technology for estimating a temperature, and more particularly to a temperature estimation apparatus applicable to a thermocoupler input module which is an expansion module of a PLC (Programmable Logic Controller) and a method thereof.

### DISCUSSION OF THE RELATED ART

Conventionally, thermocouples are a common form of contacting electrical sensor. They consist of two dissimilar metal wires, joined at their ends to form an electrical circuit. One of the junctions is attached to or embedded in the surface of the component to be measured and is referred to as the sensing or “hot” junction. The other is a reference or “cold” junction. Typically the two wires are formed into a single cable. The circuit generates a voltage due to the diffusion of electrons along the temperature gradient (the Seebeck effect), and traditionally materials have been chosen to give a voltage output, e.g., less than 100 mv, approximately proportional to the difference in temperature between the two junctions. The small voltage generated is measured at the cold junction end using a voltmeter and is converted to a temperature using a calibration for cable type of the thermocouple. The cold junction temperature is usually measured with a resistance thermometer which is generally integral with a signal conditioning unit. At this time, the voltage of the thermocoupler and temperature characteristic is a bit non-linear, where an overall temperature variation width is in the range of −250° C.˜2000° C.

That is, the thermocouples use two leads formed of dissimilar materials, for example one lead formed of constantan and the other formed of copper, that are joined at one end to form a thermocouple junction. The thermocouple junction produces a voltage, representative of the temperature, and that voltage varies as the thermocouple is exposed to various temperatures. Conventional thermocouples are often formed by joining together a pair of dissimilar metal wires, the metals having been chosen so that a voltage is observed depending on the size of the temperature difference between the joined and free ends of the pair.

Thermocouples can be used for both temperature measurement and temperature control by heating the thermocouple junction. The thermocouple effect is where a temperature differential can be converted directly into electrical energy, with the amount of electrical energy so generated providing a measurement of the temperature. The observed voltage then provides an estimate of the temperature differential along the length of the pair of wires according to standard equations well known to those of ordinary skill in the art.

This type of thermoelectric structure constitutes a thermoelectric converter enabling for example an electromotive force to be generated by Seebeck effect when a temperature gradient is applied between the cold and hot junctions.

A thermocoupler input module, which is one of expansion modules for a PLC (Programmable Logic Controller) outputs an electromotive force generated by a thermocoupler, as analogue electrical signal input in a digital data via an analogue-to-digital converter (ADC), where the digital data through the ADC needs a process of being converted to an actual temperature.

The conventional thermocoupler input module has used a method where a table must be prepared for each temperature unit when converting the digital data to an actual temperature, and a temperature corresponding to the digital data is sought after. However, the method is disadvantageous in that a conversion speed is delayed quite a long time to degrade the performance of the thermocoupler input module.

Another disadvantage is that a large capacity memory is needed to store a temperature conversion table in an OS (Operating System) program of a controller to degrade the price competitiveness due to the increased capacity of OS program.

### SUMMARY OF THE DISCLOSURE

The present invention has been made to solve disadvantages of the prior art and therefore an object of certain embodiments of the present invention is to provide a temperature estimation apparatus applicable to a thermocoupler input module for improving performance of the thermocoupler input module by speedifying a computation speed during temperature convertion in a thermocoupler, and a method thereof.

Technical subjects to be solved by the present invention are not restricted to the above-mentioned description, and any other technical problems not mentioned so far will be clearly appreciated from the following description by the skilled in the art. That is, the present invention will be understood more easily and other objects, characteristics, details and advantages thereof will become more apparent in the course of the following explanatory description, which is given, without intending to imply any limitation of the disclosure, with reference to the attached drawings.

An object of the invention is to solve at least one or more of the above problems and/or disadvantages in whole or in part and to provide at least advantages described hereinafter. In order to achieve at least the above objects, in whole or in part, and in accordance with the purposes of the invention, as embodied and broadly described, and in one general aspect of the present invention, there is provided a temperature estimation apparatus estimating a temperature of thermo-electromotive force inputted from a plurality of thermocoupler input units, the apparatus comprising: a converter converting an analogue signal corresponding to the thermo-electromotive force to a digital data; and a controller estimating a temperature corresponding to the thermo-electromotive force converted to the digital data.

Preferably, but not necessarily, the apparatus further comprises a multiplexer selecting any one of a plurality of analogue signals corresponding to the thermo-electromotive force inputted from the plurality of thermocoupler input units.

Preferably, but not necessarily, the apparatus further comprises an amplifier amplifying an analogue signal corresponding to the thermo-electromotive force.

Preferably, but not necessarily, the amplifier is an operational amplifier.

Preferably, but not necessarily, the apparatus further comprises an insulation unit interposed between the converter and the controller to insulate the digital data transmitted to the controller.

Preferably, but not necessarily, the insulation unit is a photodetector.

Preferably, but not necessarily, the controller estimates a temperature corresponding to the thermo-electromotive force using a predetermined temperature estimating function.

Preferably, but not necessarily, the predetermined temperature estimating function is defined by the following equation:

T(x)=ax⁴+bx³+cx²+dx+e, [Equation 1]
where T(x) is a temperature based on a thermo-electromotive force (x).

Preferably, but not necessarily, the ‘a’ to ‘e’ are variables in the predetermined temperature estimating function, and determined by type and temperature range of the thermocoupler input units inputted by the thermo-electromotive force.

Preferably, but not necessarily, the apparatus further comprises storage storing the variables.

In another general aspect of the present invention, there is provided a temperature estimation method, the method comprising: converting an analogue signal corresponding to a thermo-electromotive force to a digital data; and estimating a temperature corresponding to the thermo-electromotive force converted to the digital data.

Preferably, but not necessarily, the method further comprises selecting any one analogue signal from a plurality of analogue signals corresponding to a plurality of thermo-electromotive forces.

Preferably, but not necessarily, the method further comprises amplifying the analogue signal corresponding to the thermo-electromotive force.

Preferably, but not necessarily, the step of estimating the temperature includes estimating a temperature corresponding to a thermo-electromotive force, using a predetermined temperature estimating function.

Preferably, but not necessarily, the predetermined temperature estimating function is defined by the following equation:

T(x)=ax⁴+bx³+cx²+dx+e, [Equation 1]
where T(x) is a temperature based on a thermo-electromotive force (x).

Preferably, but not necessarily, the ‘a’ to ‘e’ are variables in the predetermined temperature estimating function, and determined by type and temperature range of the thermocoupler input units inputted by the thermo-electromotive force.

The present invention has an advantageous effect in that a temperature is estimated by a thermocoupler temperature estimating function, whereby the conventional delay of converting speed during temperature conversion can be improved, storage capacity for storing a temperature conversion table can be minimized and performance and economy of PLC input module can be improved.

Particular and preferred aspects of the invention are set out in the accompanying independent and dependent claims. Features from the dependent claims may be combined with features of the independent claims and with features of other dependent claims as appropriate and not merely as explicitly set out in the claims.

Although there has been constant improvement, change and evolution of devices in this field, the present concepts are believed to represent substantial new and novel improvements, including departures from prior practices, resulting in the provision of more efficient, stable and reliable devices of this nature.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

The accompanying drawings, which are included to provide a further understanding of the disclosure and are incorporated in and constitute a part of this application, illustrate embodiment(s) of the disclosure, and together with the description serve to explain the principle of the disclosure. In the drawings:

FIG. 1 is a schematic block diagram illustrating a PLC thermocoupler input module according to an exemplary embodiment of the present invention;

FIG. 2 is a flowchart illustrating a temperature conversion method of a PLC thermocoupler input module according to prior art;

FIG. 3 is a part of an exemplary temperature conversion table according to prior art;

FIG. 4 is a flowchart illustrating a temperature conversion method of a thermocoupler input module according to the present invention;

FIG. 5a is a graph illustrating a reference temperature converted by a temperature conversion method according to prior art; and

FIG. 5b is a graph illustrating a temperature estimated by a temperature estimation method according to the present invention.

### DETAILED DESCRIPTION OF PREFERRED EMBODIMENTS

Various exemplary embodiments will be described more fully hereinafter with reference to the accompanying drawings, in which some exemplary embodiments are shown. The present inventive concept may, however, be embodied in many different forms and should not be construed as limited to the example embodiments set forth herein. Rather, these exemplary embodiments are provided so that this description will be thorough and complete, and will fully convey the scope of the present inventive concept to those skilled in the art.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Descriptions of well-known components and processing techniques are omitted so as to not unnecessarily obscure the embodiments of the disclosure.

Hereinafter, a temperature estimation apparatus and a method in thermocoupler input module of PLC will be described in detail with reference to the accompanying drawings.

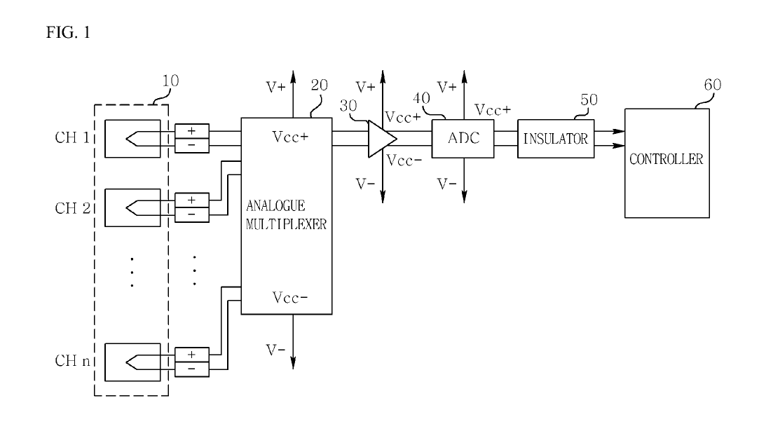

FIG. 1 is a schematic block diagram illustrating a PLC thermocoupler input module according to an exemplary embodiment of the present invention.

Referring to FIG. 1, the PLC thermocoupler input module according to an exemplary embodiment of the present invention includes a thermocoupler input unit (10), an analogue multiplexer (20), an amplifier (30), an Analogue-to-Digital Converter (ADC, 40), an insulator (50) and a controller (60). The controller (60) in the thermocoupler input module according to the exemplary embodiment of the present invention is a MPU (Micro Processor Unit), for example, but is not limited thereto.

The thermocoupler input unit (10) inputs a voltage (thermo-electromotive force) generated by heat generated by a junction of a metal. FIG. 1 exemplifies that each of n (n is a natural number) number of channels (CH1˜CHn) is formed with a thermocoupler input unit (10).

The analogue multiplexer (20) selects an actually convertible (to be converted) signal among signals inputted from the n number of channels (CH1 to CHn). The amplifier (30) amplifies the input signal to a voltage appropriate for input to the ADC (40). Although the amplifier (30) is an operational amplifier, for example, but it is not limited thereto. The ADC (40) converts the inputted analogue signal to a digital data. The insulator (50) serves to insulate an analogue circuit inside the PLC thermocoupler input module from a digital circuit, and transmit a signal to the controller (60). That is, the insulator (50) insulates the digital signal that is transmitted to the controller (60). The insulator (50) is a photocoupler, for example, but is not limited thereto.

The controller (60) controls the analogue multiplexer (20), the amplifier (30), the ADC (40) and the insulator (50), receives the converted digital signal to estimate a temperature corresponding to a relevant thermo-electromotive force and outputs the estimated temperature. The temperature estimation by the controller (60) will be described in detail with reference to the accompanying drawings.

Although not illustrated in the figure, the PLC thermocoupler input module may include a power input unit, which in turn supplies a driving power to the PLC thermocoupler input module.

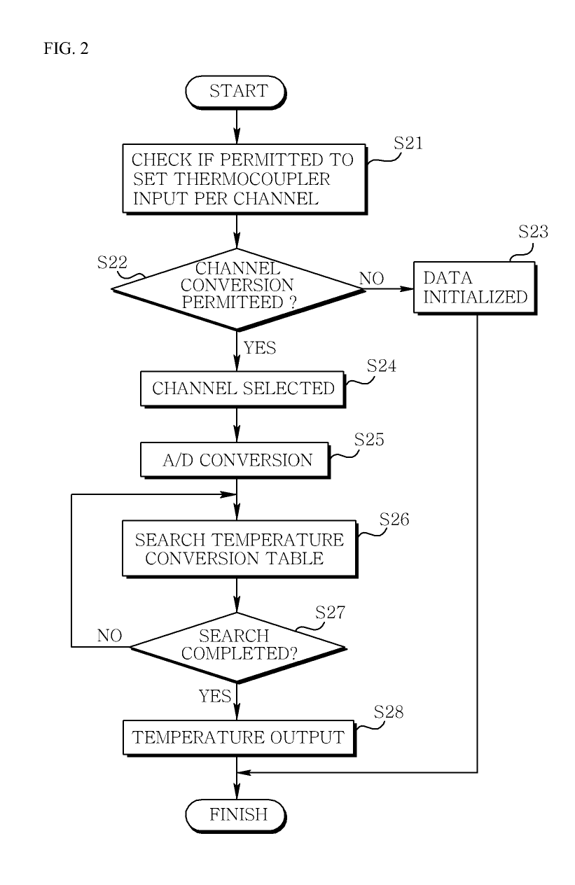

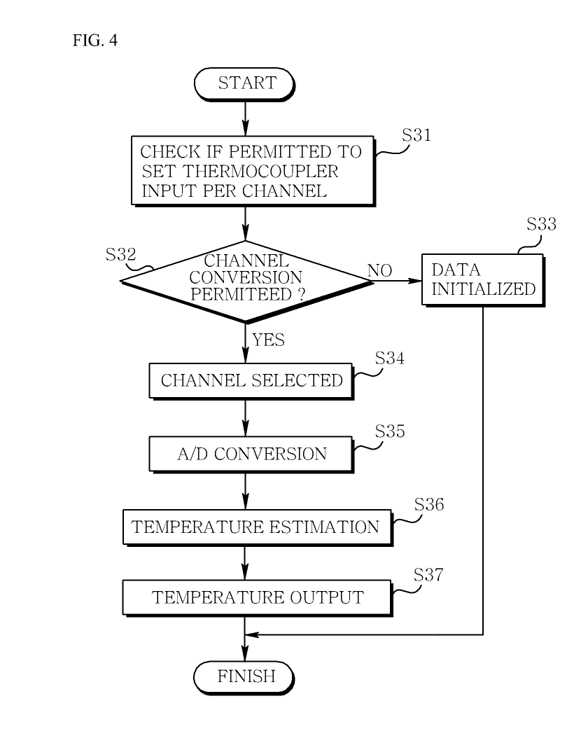

Now, a temperature conversion method of a PLC thermocoupler input module according to prior art will be described with reference to FIG. 2, and a temperature conversion method of the thermocoupler input module of FIG. 1 according to the present invention, will be described with reference to FIG. 4.

FIG. 2 is a flowchart illustrating a temperature conversion method of a PLC thermocoupler input module according to prior art. The constituent elements according to the present invention will be described as those of FIG. 1, but it should be apparent that the controller (60) according to the present invention is different from a controller of FIG. 2 in terms of functions.

As illustrated in the figure, the temperature conversion method of the PLC thermocoupler input module according to prior art is to check if conversion to each channel of the thermocoupler input unit is permitted (S21), and if the channel conversion is not permitted (S22), data is initialized (S23) and the operation ends. At S22, if it is determined that the channel conversion is permitted, a channel of actually convertible thermocoupler input unit is selected (S24) and a relevant signal is amplified. Successively, a register is calculated that is necessary for performing the analogue/digital conversion, where an analogue signal of thermo-electromotive force inputted from the thermocoupler input unit is converted to a digital data (S25). Thereafter, an actual temperature corresponding to the digital data is searched from a temperature conversion table (S26).

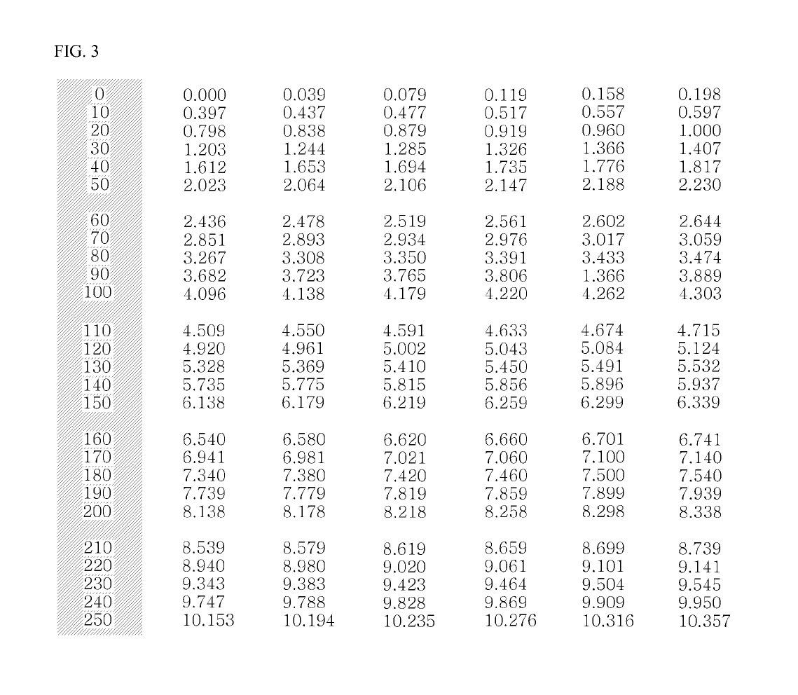

FIG. 3 is a part of an exemplary temperature conversion table according to prior art, in which a temperature to a digital data corresponding to each electromotive force is converted per 1° C. unit. To this end, storage was conventionally mounted on a PLC thermocoupler input module, although not illustrated.

Referring to FIG. 3, the conventional temperature conversion table is configured in thermo-electromotive force (mV) corresponding to a temperature of 1° C. unit. For example, 0 mV in K type thermocoupler in FIG. 3 means 0° C.

As noted from the foregoing, in the conventional thermocoupler input module, an A/D converted thermo-electromagnetic force is compared in one-on-one base in the temperature table, and the comparative search was conducted until a measured thermo-electromagnetic force matches a reference thermo-electromagnetic force. For example, if a value inputted from the thermocoupler input unit is K type thermocoupler, and the converted thermo-electromagnetic force is 47,336 mV, a temperature of 1,160° C. corresponding to a relevant thermo-electromagnetic force is outputted in the temperature conversion table according to the conventional temperature conversion method.

That is, search of the temperature conversion table is performed on an entire table (S27) to output the converted temperature (S28). Now, the temperature conversion of the PLC thermocoupler input module ends through this process. In other words, in the conventional PLC thermocoupler input module, a temperature conversion table designated for each 1° C. unit is searched to output a temperature conversion, such that a broad temperature range (−250° C. to 2,000° C.) must be searched in view of thermocoupler characteristic, whereby an operational speed performance of the PLC thermocoupler input module was degraded due to generated delay in the conversion speed. Furthermore, a large capacity memory was needed to store data of thermo-electromagnetic forces in a broad temperature range to inevitably decrease the price competitiveness.

To address the aforementioned disadvantages, unlike the conventional technique of performing the temperature conversion by searching for the temperature conversion table, the temperature estimation apparatus according to the present invention has a technical characteristic in that a temperature corresponding to a thermo-electromagnetic force is estimated by inputting the A/D converted digital data to a temperature conversion function to thereby derive an actual temperature corresponding to the thermo-electromagnetic force.

Now, a detailed description thereto is provided hereunder.

FIG. 4 is a flowchart illustrating a temperature conversion method of a thermocoupler input module according to the present invention.

Referring to FIG. 4, the temperature estimation method according to the present invention is for the controller (60) to check if temperature estimation per channel of the thermocoupler input unit (10) is permitted (S31), and as a result of check by the controller (60), if the temperature estimation is not permitted (S32), data is initialized (S33) and the operation ends.

At S32, if it is determined that the channel conversion is permitted, the analogue multiplexer (20) is controlled to select a channel of actually convertible thermocoupler input unit (S34) where the amplifier (30) amplifies a relevant signal. Successively, the ADC (40) calculates a register that is necessary for performing the analogue/digital conversion (not shown), where an analogue signal corresponding to a thermo-electromotive force inputted from the thermocoupler input unit (10) is converted to a digital data (S35). Thereafter, the controller (60) of the PLC thermocoupler input module according to the present invention estimates an actual temperature corresponding to the digital data inputted through the insulator (50) (S36). To be more specific, the controller (60) according to the present invention inputs the A/D converted digital data to the temperature estimation function to output an actual corresponding temperature (S37).

To be further specific, the temperature estimation function used for temperature estimation is provided in the following equation 1.

T(x)=ax⁴+bx³+cx²+dx+e, [Equation 1]

where, T(x) is an estimated temperature of quartic equation, x is a thermo-electromotive force (mV), a to e are variables and vary depending on type of thermocoupler and temperature section. For example, in the K type thermocoupler, a=−0.004174, b=0.090509, c=−0.584159, d=25.590167 and e=−0.066700 in the 0 to 250° C. section.

To this end, the temperature estimation apparatus may further include storage (not shown) for storing the abovementioned variables. However, unlike the prior art of FIG. 2, the storage just stores 5 variables of 64 bytes, such that storage of much smaller capacity may be mounted over that of the prior art.

The following table is provided to compare a reference temperature converted in the temperature conversion table of FIG. 3 with an estimation temperature estimated by the controller (60) according to the present invention.

TABLE 1

| Thermo- | | | |
|---|---|---|---|
| electromotive force | Reference | Estimation | |
| (mv) | temperature (° C.) | temperature (° C.) | Error (° C.) |
| 0 | 0 | −0.07 | 0.07 |
| 2.023 | 50 | 49.99 | 0.01 |
| 4.096 | 100 | 99.99 | 0.01 |
| 6.138 | 150 | 150.00 | 0.00 |
| 8.138 | 200 | 199.97 | 0.03 |
| 10.153 | 250 | 250.01 | 0.01 |

As apparent from the foregoing table, it can be noted that the reference temperature obtained by the conventional temperature conversion method and the estimation temperature obtained by the temperature estimation method according to the present invention satisfy an error range of within an approximately 0.1° C.

That is, in comparison with the conventional temperature conversion method requiring as much data capacity as 64×250 data for storing 250 data (storing data of 0˜250° C. at every 1° C.), the temperature estimation according to the present invention requires a 64 bit×5 data capacity to perform the temperature estimation within a much faster time, if only 5 variables (a to e) are stored.

However, the aforementioned variables are restricted to a partial temperature section of the K type thermocoupler, and the variables related to the temperature estimation may be changed depending on types of the thermocoupler and the temperature range, and it should be apparent to the skilled in the art that types of the thermocoupler and temperature range can be protected by the scope of claim according to the present invention regardless of accurate values to the variables.

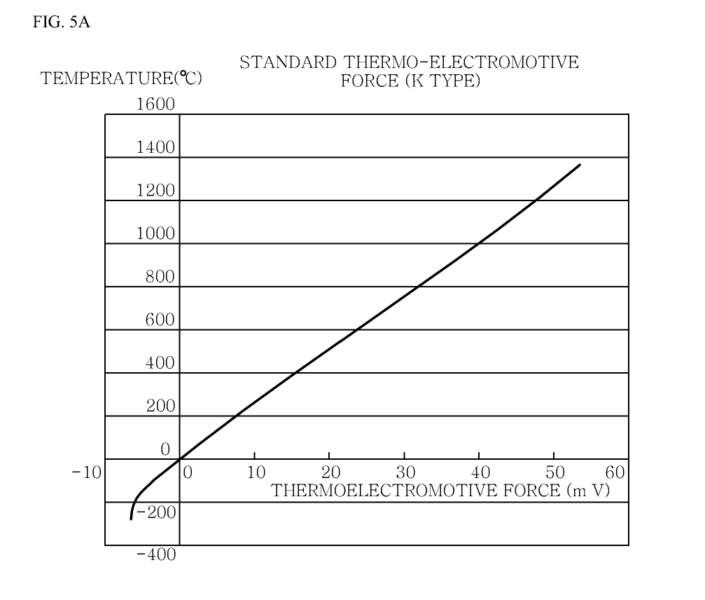

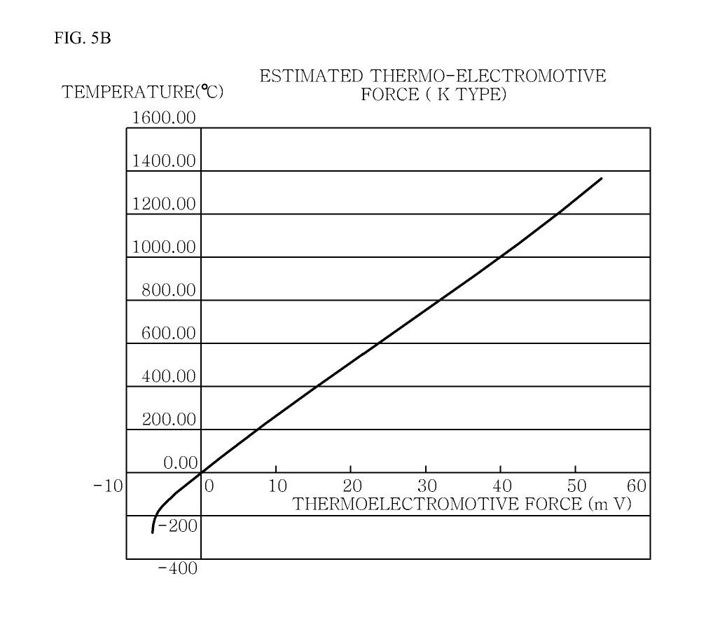

FIG. 5a is a graph illustrating a reference temperature converted by a temperature conversion method according to prior art, and FIG. 5b is a graph illustrating a temperature estimated by a temperature estimation method according to the present invention, where both FIGS. 5a and 5b illustrate graphs according to a temperature range of K type thermocoupler.

As shown in FIGS. 5a and 5b, it can be noted that the estimation temperatures according to the present invention satisfy an error range of 0.1° C. in the K type temperature section.

As apparent from the foregoing, the temperature estimation apparatus and a method in thermocoupler input module of PLC according to the present invention has an industrial applicability in that the conventional conversion speed can be improved during temperature conversion through the temperature estimation using a thermocoupler temperature estimation function while maintaining intact the configuration of the conventional PLC thermocoupler input module, storage capacity for storing the temperature conversion table can be minimized, and performance and economy of PLC input module can be increased at the same time.

The previous description of the present invention is provided to enable any person skilled in the art to make or use the invention. Various modifications to the invention will be readily apparent to those skilled in the art, and the generic principles defined herein may be applied to other variations without departing from the spirit or scope of the invention. Thus, the invention is not intended to limit the examples described herein, but is to be accorded the widest scope consistent with the principles and novel features disclosed herein.

What is claimed is:

1. A temperature estimation apparatus estimating a temperature of thermo-electromotive force inputted from a plurality of thermocoupler input units, the apparatus comprising: a converter converting an analogue signal corresponding to the thermo-electromotive force to a digital data; and a controller estimating a temperature corresponding to the thermo-electromotive force converted to the digital data.

2. The apparatus of claim 1, further comprising a multiplexer selecting any one of a plurality of analogue signals corresponding to the thermo-electromotive force inputted from the plurality of thermocoupler input units.

3. The apparatus of claim 1, further comprising an amplifier amplifying an analogue signal corresponding to the thermo-electromotive force.

4. The apparatus of claim 3, wherein the amplifier is an operational amplifier.

5. The apparatus of claim 1, further comprising an insulation unit interposed between the converter and the controller to insulate the digital data transmitted to the controller.

6. The apparatus of claim 5, wherein the insulation unit is a photodetector.

7. The apparatus of claim 1, wherein the controller estimates a temperature corresponding to the thermo-electromotive force using a predetermined temperature estimating function.

8. The apparatus of claim 7, wherein the predetermined temperature estimating function is defined by the following equation:
T(x)=ax⁴+bx³+cx²+dx+e, [Equation 1]
where T(x) is a temperature based on a thermo-electromotive force (x).

9. The apparatus of claim 8, wherein the ‘a’ to ‘e’ are variables in the predetermined temperature estimating function, and determined by type and temperature range of the thermocoupler input units inputted by the thermo-electromotive force.

10. The apparatus of claim 8, further comprising storage storing the variables.

11. A temperature estimation method, the method comprising: converting an analogue signal corresponding to a thermo-electromotive force to a digital data; and estimating a temperature corresponding to the thermo-electromotive force converted to the digital data.

12. The method of claim 11, further comprising selecting any one analogue signal from a plurality of analogue signals corresponding to a plurality of thermo-electromotive forces.

13. The method of claim 11, further comprising amplifying the analogue signal corresponding to the thermo-electromotive force.

14. The method of claim 11, wherein the step of estimating the temperature includes estimating a temperature corresponding to the thermo-electromotive force, using a predetermined temperature estimating function.

15. The method of claim 14, wherein the predetermined temperature estimating function is defined by the following equation:
T(x)=ax⁴+bx³+cx²+dx+e, [Equation 1]
where T(x) is a temperature based on a thermo-electromotive force (x).

16. The method of claim 15, wherein the ‘a’ to ‘e’ are variables in the predetermined temperature estimating function, and determined by type and temperature range of the thermocoupler input units inputted by the thermo-electromotive force.
